(19) United States
(12) Patent Application Publication
(10) Pub. No.: US 2011/0171520 A1
(43) Pub. Date: Jul. 14, 2011

(54) AA BATTERY

(76) Inventor: Yasushi Sumihiro, Hyogo (JP)

(21) Appl. No.: 12/936,867

(22) PCT Filed: Apr. 5, 2010
(86) PCT No.: PCT/JP2010/002481

§ 371 Date: Oct. 7, 2010

(30) Foreign Application Priority Data
Jul. 8, 2009 (JP) 2009-161285

(51) Int. Cl. H01M 2/02; H01M 6/08

(52) U.S. Cl. 429/169

(57) ABSTRACT

Power-generating elements (a positive electrode 2, a negative electrode 3, and a separator 4) are included in a cylindrical battery case 1 with a base, and a raised portion at the center of a bottom surface of the battery case 1 forms a positive electrode terminal 30. The maximum outer diameter L (mm) of a battery 10 and the radius r (mm) of an arc of a shoulder portion 20 close to the positive electrode terminal 30 of the battery case 1 satisfy the following relationships: 14.20 mm≦L≦14.35 mm, and r≧L−13.9 mm.

### RELATED APPLICATIONS

This application is the U.S. National Phase under 35 U.S.C. §371 of International Application No. PCT/JP2010/002481, filed on Apr. 5, 2010, which in turn claims the benefit of Japanese Application No. 2009-161285, filed on Jul. 8, 2009, the disclosures of which Applications are incorporated by reference herein.

### TECHNICAL FIELD

The present invention relates to AA batteries whose shape is defined by the JIS standard (LR6 by the IEC standard and AA by the ANSI standard).

### BACKGROUND ART

Presently, as AA batteries, alkaline dry batteries, manganese dry batteries, and the like are mainly manufactured and sold. Batteries of these kinds are widely used as main power supply for daily commodities, toys, hobby goods, game instruments, portable music players, electronic devices, and the like, and are desired to have a long life when being used in a device.

To achieve a long driving time of a device, a capacity of a battery has to be increased. To achieve this, a capacity of a battery is increased by increasing a size of a battery within the range defined by the JIS standard as well as by increasing a capacity of positive and negative materials which are power-generating elements of a battery (see, for example, PATENT DOCUMENT 1). Specifically, in an AA battery whose shape is defined to be a long and thin cylindrical shape by the JIS standard, the outer diameter of the battery largely contributes to increase in battery capacity.

FIG. 5 is a cross-sectional view of a typical AA battery 100 having a cylindrical shape. An outer diameter of the AA battery 100 is determined by an outer diameter R of a battery case 101 in which an electric power element 102 is included and a thickness T of an exterior label 103 for covering an outer surface of the battery case 1 and ensuring insulation.

The AA battery 100 has a maximum outer diameter in part of the AA battery 100 in which the exterior label 103 overlaps. Specifically, a dimension (R+3T) obtained by adding a thickness 3T of three layers of the exterior label 103 to the outer diameter R of the battery case 101 is the maximum outer diameter of the AA battery 100. The outer diameter of an AA battery defined by the JIS standard is 14.5 mm at a maximum.

### CITATION LIST

### Patent Document

PATENT DOCUMENT 1: Japanese Translation of PCT International Application No. 2002-532851

### SUMMARY OF THE INVENTION

### Technical Problem

However, in actual situations, the maximum outer diameter of known AA batteries is 14.0-14.2 mm for alkaline dry batteries and 13.8-14.1 mm for manganese dry batteries. This is because various inconveniences arise when AA batteries having larger maximum outer diameters are inserted in electronic devices.

It is an objective of the present invention to provide a large-capacity AA battery, where the maximum outer diameter of the battery can be larger, but inconveniences do not arise in inserting the battery in an electronic device.

### Solution to the Problem

An AA battery according to an aspect of the present invention includes: power-generating elements included in a cylindrical battery case with a base; and a positive electrode terminal formed at the center of a bottom surface of the battery case, wherein a maximum outer diameter L (mm) of the battery and a radius r (mm) of an arc of a shoulder portion close to the positive electrode terminal of the battery case satisfy the relationships: 14.20 mm≦L≦14.35 mm, and r≧L−13.9 mm.

With this configuration, even when the maximum outer diameter of an AA battery is large, the battery can smoothly be inserted in an electronic device. Thus, it is possible to provide a large-capacity AA battery which does not result in non-continuity. The non-continuity occurs when a positive electrode terminal of the battery is not in contact with a terminal of an electronic device.

In another aspect of the present invention, the radius (r) of the arc of the shoulder portion close to the positive electrode terminal of the battery case is 0.5 mm or larger, the positive electrode terminal is made of a raised portion formed at the center of the bottom surface of the battery case, and a height of the raised portion is in a range from 1.48 mm to 1.60 mm. With this configuration, it is possible to further increase the capacity of an AA battery, but inconveniences do not arise in inserting the battery in an electronic device.

### Advantages of the Invention

According to the present invention, it is possible to provide a large-capacity AA battery, where the maximum outer diameter of the battery can be larger, but inconveniences do not arise in inserting the battery in an electronic device.

### BRIEF DESCRIPTION OF THE DRAWINGS

FIG. 1 is a half sectional view illustrating a configuration of an AA battery in an embodiment of the present invention.

FIG. 2(a) is a view illustrating the battery inserted in a battery holder, wherein the battery is in a non-continuity state. FIG. 2(b) is an enlarged view illustrating a shoulder portion close to a positive electrode terminal of the battery.

FIG. 3 is a graph illustrating the relationship between the maximum outer diameter of a battery and the radius of an arc of a case shoulder portion in terms of non-continuity when the battery is inserted in a device.

FIG. 4(a) is a partial cross-sectional view illustrating a variation of the shape of the positive electrode terminal. FIG. 4(b) is a partial cross-sectional view illustrating a variation of the shape of the positive electrode terminal. FIG. 4(c) is a partial cross-sectional view illustrating a variation of the shape of the positive electrode terminal.

FIG. 5 is a cross-sectional view of a known cylindrical AA battery.

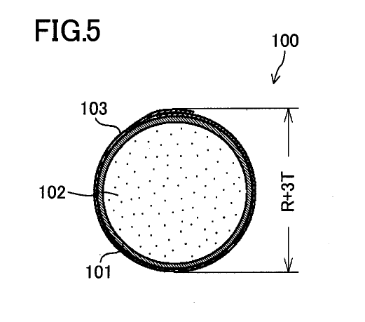

### DESCRIPTION OF EMBODIMENTS

Embodiments of the present invention will be described in detail below with reference to the drawings. Note that the present invention is not limited to the following embodiments. The embodiments can be modified without deviating from the effective scope of the invention, and can be combined with other embodiments.

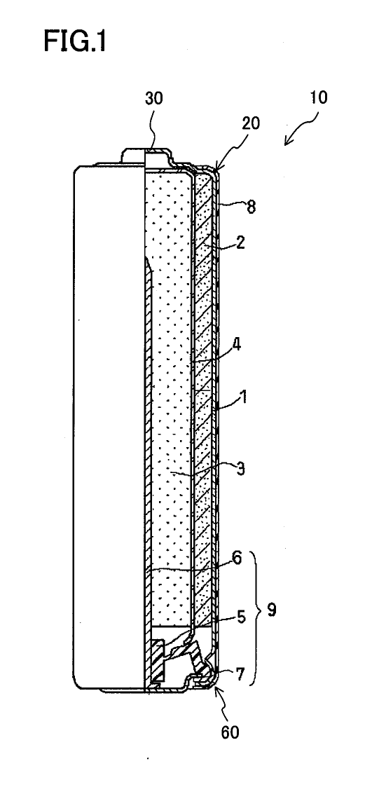

FIG. 1 is a half sectional view schematically illustrating a configuration of an AA alkaline dry battery 10 according to an embodiment of the present invention. Note that the battery of the present embodiment is an AA battery whose outer diameter is defined by the JIS standard (LR6 by the IEC standard and AA by the ANSI standard).

As shown in FIG. 1, power-generating elements (a positive electrode 2, a negative electrode 3, and a separator 4) of the battery 10 are included in a battery case 1. The battery case 1 has a cylindrical shape with a base, and also serves as a positive electrode terminal 30. An opening portion of the battery case 1 is sealed with a sealing body 9 which is a united body of a gasket 5, a negative electrode current collector 6, and a negative electrode terminal plate 7. An outer surface of the battery case 1 is covered by an insulating exterior label 8.

The inventor of the present application formed batteries 10 so that respective maximum outer diameters of the batteries differ, and inserted these batteries in devices in which an AA battery was used as a power supply. Then, the inventor examined inconveniences arising in inserting the batteries. In the examination, 50 models of devices including daily commodities, toys, hobby goods, game instruments, portable music players, and electronic devices were used.

Here, Batteries A-F were formed so that the total height of each battery 10 was 50.20 mm, the thickness (T) of each exterior label 8 was 0.07 mm, and respective outer diameters (R) of the battery cases 1 differ by 0.05 mm in the range from 13.90 mm to 14.15 mm.

Table 1 shows results of the examination. Batteries A and B in which the maximum outer diameters (R+3T) of the batteries 10 were 14.16 mm or smaller did not result in non-continuity when inserted in devices. However, Batteries C-F in which the maximum outer diameters were 14.21 mm or larger resulted in non-continuity when inserted in some of the devices. The non-continuity resulted from the fact that the positive electrode terminal 30 made of a raised portion at the center of the base surface of the battery case 1 was not in contact with a terminal of the device.

TABLE 1

| | | | | The Number of |
|---|---|---|---|---|
| | | | | Devices in which |
| | | | Maximum | Inserted Battery |
| | Thickness | | Outer | is in a |
| | (T) of | Outer Diameter | Diameter | Non-continuity |
| | Exterior | (R) of Battery | (R + 3T) of | State |
| | Label | Case | Battery | Per 50 Models of |
| | mm | mm | mm | the Devices |
| Battery A | 0.07 | 13.90 | 14.11 | 0 |
| Battery B | | 13.95 | 14.16 | 0 |
| Battery C | | 14.00 | 14.21 | 2 |
| Battery D | | 14.05 | 14.26 | 2 |
| Battery E | | 14.10 | 14.31 | 2 |
| Battery F | | 14.15 | 14.36 | 3 |

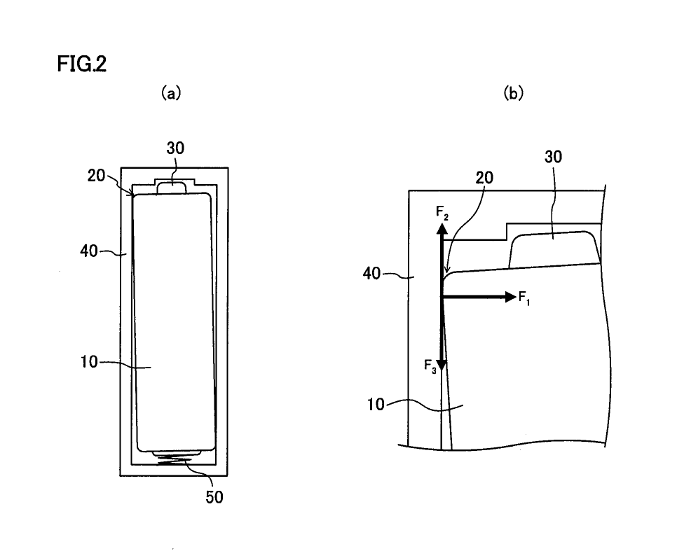

FIG. 2(a) shows the battery 10 inserted in a battery holder 40 of a device, wherein the battery 10 is in a non-continuity state. FIG. 2(b) is an enlarged view of a shoulder portion 20 close to the positive electrode terminal 30 of the battery 10.

When the maximum outer diameter of the battery 10 is large, the space between the outer circumference of the battery 10 and the battery holder 40 is small. Thus, as illustrated in FIG. 2(a), when the battery 10 is inserted at a slight angle, the shoulder portion 20 of the battery 10 is in contact with an inner wall of the battery holder 40. At this time, as illustrated in FIG. 2(b), to the shoulder portion 20 of the battery 10 which is in contact with the inner wall of the battery holder 40, a force F₂ is applied from a spring 50 which is in contact with a negative electrode terminal, a counterforce F₁ is applied from the inner wall of the battery holder 40, and a frictional force F₃ between the outer circumference of the battery 10 and the inner wall of the battery holder 40 is applied. Here, if the frictional force F₃ is larger than the force F₂ applied from the spring 50, the battery 10 is kept in an inclined state when inserted in the battery holder 40. As a result, the positive electrode terminal 30 cannot come into contact with a terminal of the battery holder 40, resulting in non-continuity.

The battery case 1 includes, as illustrated in FIG. 1, a crimped portion 60, i.e., an opening edge portion of the battery case 1 inwardly bent into an arc shape to pinch the gasket 5 in addition to the shoulder portion 20 close to the positive electrode terminal 30. The radius of the arc of the shoulder portion 20 close to the positive electrode terminal 30 is preferably small to ensure a large capacity of the battery. For this reason, the radius of the arc of the shoulder portion 20 close to the positive electrode terminal 30 is generally smaller than that of the crimped portion 60.

Then, the inventor of the present application assumed that the frictional force F₃ between the outer circumference of the battery 10 and the inner wall of the battery holder 40 is restricted by the size of the arc of the shoulder portion 20 close to the positive electrode terminal 30. The inventor formed batteries so that the sizes of arcs of shoulder portions 20 close to positive electrode terminals 30 differ, and inserted these batteries in devices in which an AA battery was used as a power supply. Then, the inventor examined inconveniences arising in inserting the batteries as in Table 1.

Here, from Batteries shown in Table 1 which were resulted in non-continuity when inserted in the devices, Battery C having a maximum outer diameter of 14.21 mm and Battery E having a maximum outer diameter of 14.31 mm were selected as standards (in which the radius of the arc of each shoulder portion 20 is 0.3 mm). Batteries C, E, and G-L were formed so that respective radii (r) of the arcs of the shoulder portions 20 close to the positive electrode terminals 30 of the battery cases 1 differ in the range from 0.3 mm to 0.7 mm.

Table 2 shows the result of the examination. Of Batteries having a maximum outer diameter of 14.21 mm, Batteries G-I in which the radii of the arcs of the case shoulder portions 20 were 0.4 mm or larger did not result in non-continuity. In contrast, of Batteries having a maximum outer diameter of 14.31 mm, Batteries K-L in which the radii of the arcs of the case shoulder portions 20 were 0.5 mm or larger did not resulted in non-continuity.

From the results, it can be assumed that when the radius (r) of the arc of the case shoulder portion 20 was large, the frictional force F₃ between the outer circumference of the battery 10 and the inner wall of the battery holder 40 was small, so that the battery 10 was smoothly inserted in the battery holder 40, allowing the positive electrode terminal 30 to come into contact with a terminal of the device.

TABLE 2

| | | | The Number of Devices |
|---|---|---|---|
| | | Radius (r) | in which Inserted |
| | Maximum Outer | of Arc of | Battery is in a |
| | Diameter | Case Shoulder | Non-continuity State |
| | (R + 3T) | Portion | Per 50 Models of the |
| | mm | mm | Devices |
| Battery C | 14.21 | 0.3 | 2 |
| Battery G | | 0.4 | 0 |
| Battery H | | 0.5 | 0 |
| Battery I | | 0.7 | 0 |
| Battery E | 14.31 | 0.3 | 2 |
| Battery J | | 0.4 | 2 |
| Battery K | | 0.5 | 0 |
| Battery L | | 0.7 | 0 |

In contrast, if the maximum outer diameter of the battery 10 is larger, the space between the outer circumference of the battery 10 and the battery holder 40 is smaller, so that the angle of inclination of the battery 10 illustrated in FIG. 2(a) is smaller. Thus, it is less likely to provide the advantage that the frictional force F₃ is reduced by the shoulder portion 20 of the battery case 1. This is probably the reason why Battery G which is smaller in terms of the maximum outer diameter did not result in non-continuity whereas Battery J which is larger in terms of the maximum outer diameter resulted in non-continuity although Batteries G and J have the same radius of the arc of the case shoulder portion 20.

Based on the above findings, the maximum outer diameter of the battery 10 and the radius of the arc of the shoulder portion 20 of the battery case 1 are set to be in an optimal range, so that it is possible to reduce the frictional force F₃ between the outer circumference of the battery 10 and the inner wall of the battery holder 40, allowing the battery 10 to smoothly be inserted in the battery holder 40.

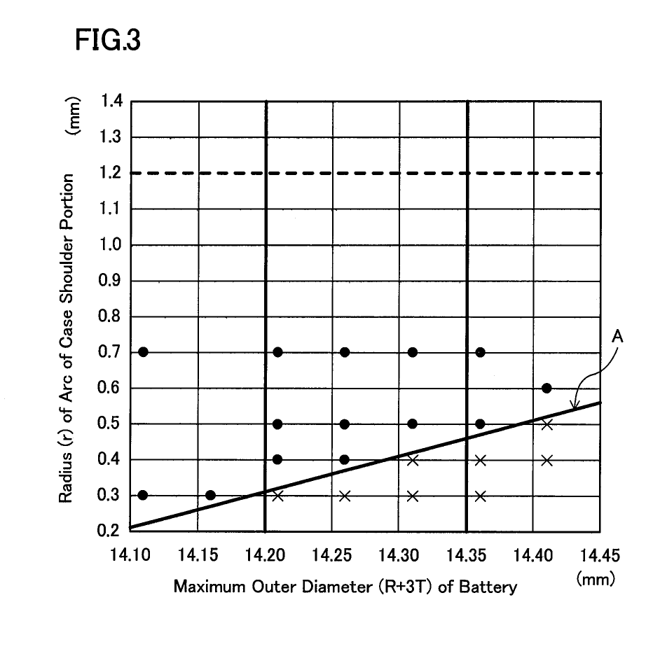

FIG. 3 is a graph showing results of an examination conducted on inconveniences arising in inserting batteries which were formed so that respective maximum outer diameters (R+3T) of batteries 10 and radii (r) of arcs of case shoulder portions 20 differ as in Table 1. Here, black circles represent, in 50 models of devices, batteries which did not result in non-continuity, and x marks represent batteries which resulted in non-continuity. Note that some of the batteries 10 having a maximum outer diameter of 14.40 mm were not able to be inserted in the battery holder 40.

The straight line A in FIG. 3 can be approximated to the expression r=L−13.9 mm, where L=R+3T. Thus, in order to smoothly insert the battery 10 in the battery holder 40, and to prevent non-continuity between the positive electrode terminal 30 and the battery holder 40, the maximum outer diameter L (mm) of the battery 10 and the radius r (mm) of the arc of the shoulder portion 20 close to the positive electrode terminal 30 of the battery case 1 may be set to be in a range in which the following relationship (1) is satisfied.

r≧L−13.9 mm (1)

Note that if the radius (r) of the arc of the case shoulder portion 20 is too large, the battery capacity decreases, and thus a radius (r) which is too large is not preferable to increase the capacity. Thus, the radius (r) of the arc of the case shoulder portion 20 is preferably 1.2 mm or smaller.

Moreover, in order to increase the capacity, it is also preferable that the maximum outer diameter (L) of the battery 10 is 14.20 mm or larger. Furthermore, to ensure the inserting of the battery 10 in the battery holder 40, the maximum outer diameter (L) of the battery 10 is preferably 14.35 mm or smaller.

In view of the above mentioned maximum outer diameter of the battery 10, the outer diameter of the battery case 1 is preferably 14.15 mm or smaller. Then, in order to increase the capacity, the outer diameter of the battery case 1 may be larger than 13.95 mm, may preferably be 14.00 mm or larger, and may more preferably be 14.05 mm or larger.

Here, the arc of the case shoulder portion 20 does not have to have a certain curvature. A “radius of an arc” in the present invention means an average value of a curvature radius at three arbitrary points (or more points) on the arc of the case shoulder portion 20.

Moreover, if a protective layer, e.g., varnish, or the like which provides wear resistance and lubricating property is provided on the surface of the exterior label 8, the battery 10 can be more smoothly inserted in a device. The protective layer is preferably made of an ultraviolet cure varnish because coating can be easily performed.

When the battery holder 40 is provided with a mechanism to be in a non-continuity state in case a battery is reversely inserted, the raised portion of the positive electrode terminal 30 has a certain height so that the positive electrode terminal 30 does not result in non-continuity even when the battery 10 is inserted at an angle in the battery holder 40.

The present invention provides the advantage of preventing non-continuity in inserting the battery 10 even in the case of a large maximum outer diameter of the battery 10. This means that the battery 10 is inserted in a device with the inclination of the battery 10 being small.

Then, in order to prove that the advantage of preventing non-continuity when a battery is inserted in a device is provided even when the height of the raised portion forming the positive electrode terminal 30 is small, batteries were formed so that the heights of raised portions forming positive electrode terminals 30 differ. Then, as in Table 1, these batteries were inserted in devices in which an AA battery was used as a power supply to examine inconveniences in inserting the batteries.

Table 3 shows results of the examination. As illustrated in Table 3, Batteries K-O in which the height (D) of the raised portion of each positive electrode terminal 30 was 1.48 mm or larger did not result in non-continuity when the radius (r) of the arc of each case shoulder portion 20 was 0.5 mm. Note that in batteries in which the radii (r) of arcs of case shoulder portions 20 are larger than 0.5 mm, the advantage of reducing the frictional force F₃ between the outer circumference of the battery 10 and the inner wall of the battery holder 40 may more effectively be produced. Thus, when the radius (r) of the arc of the case shoulder portion 20 is 0.5 mm or larger, and the height (D) of the raised portion forming the positive electrode terminal 30 is in the range from 1.48 mm to 1.60 mm, it is possible to provide a battery which has a large capacity but does not result in non-continuity.

TABLE 3

| | | | | The Number of |
|---|---|---|---|---|
| | | | Height (D) of | Devices in which |
| | Maximum | Radius (r) | Raised | Inserted Battery |
| | Outer | of Arc | Portion of | is in a |
| | Diameter | of Case | Positive | Non-continuity |
| | (R + 3T) of | Shoulder | Electrode | State |
| | Battery | Portion | Terminal | Per 50 Models of |
| | mm | mm | mm | the Devices |
| Battery K | 14.31 | 0.5 | 1.60 | 0 |
| Battery M | | | 1.58 | 0 |
| Battery N | | | 1.53 | 0 |
| Battery O | | | 1.48 | 0 |
| Battery P | | | 1.45 | 2 |

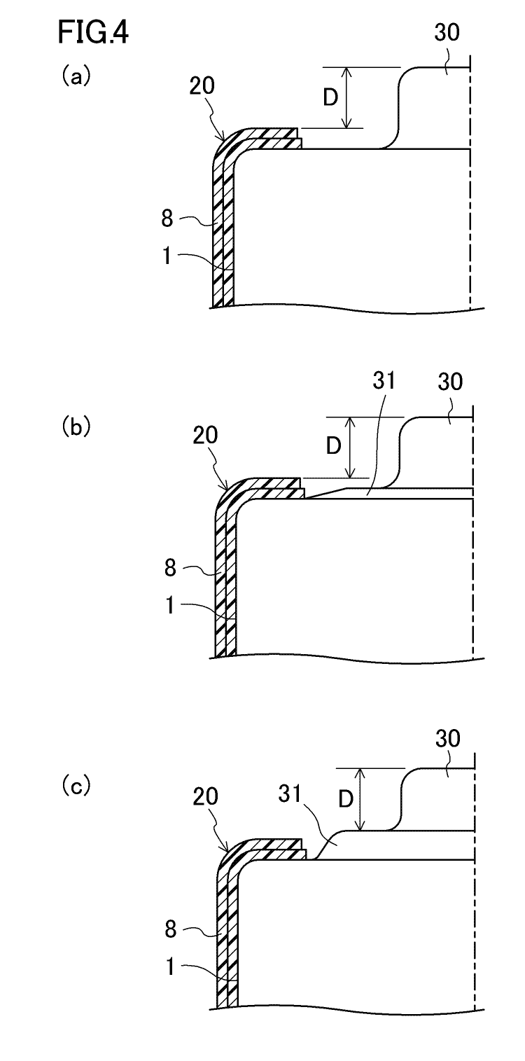

Note that the positive electrode terminal 30 may have any shape as illustrated in FIGS. 4(a)-4(c), where the height (D) of the raised portion of the positive electrode terminal 30 of the present invention means the dimension illustrated in FIGS. 4(a)-4(c). That is, in positive electrode terminals having shapes illustrated in FIGS. 4(a) and 4(b), the height means the distance between a flat plane of the raised portion of the positive electrode terminal 30 and a flat plane of the exterior label 8, and in positive electrode terminals having a shape illustrated in FIG. 4(c), the height means the distance between a flat plane of the raised portion of the positive electrode terminal 30 and a flat plane of an intermediate stepped portion 31.

Here, in a battery whose positive electrode terminal 30 has the shape illustrated in FIG. 4(a) or 4(b), the thickness of an exterior label 8 is preferably in the range from 0.05 mm to 0.10 mm. If the thickness of the exterior label 8 is larger than 0.10 mm, the substantial length of its battery case 1 is smaller when the height (D) of the raised portion of the positive electrode terminal 30 is in the range mentioned above, which reduces the capacity of the battery. Moreover, if the thickness of the exterior label 8 is smaller than 0.05 mm, the strength of the exterior label 8 is reduced, so that the exterior label 8 may be broken at the time of inserting the battery.

Moreover, in a battery having the shape illustrated in FIG. 4(b), it is preferable that the thickness of the exterior label 8 is smaller than the height of the intermediate stepped portion 31 of the positive electrode terminal 30, and the thickness of a portion where two layers of the exterior label 8 overlap (the thickness which is two times as large as the thickness of the exterior label 8) is larger than the height of the intermediate stepped portion 31 of the positive electrode terminal 30. With this configuration, when the battery is inserted in a device, even if there are some obstacles (e.g., hang-ups), and outer one of the two overlapping layers of the exterior label 8 is turned up, inner one of the two overlapping layers of the exterior label 8 whose thickness is smaller than the height of the intermediate stepped portion 31 of the positive electrode terminal 30 can be left without being damaged. That is, this configuration provides the unexpected advantage that the exterior label 8 is not broken even when the battery is forcedly inserted in a device. For example, the thickness of the exterior label 8 may be 0.08 mm, and the height of the intermediate stepped portion of the positive electrode terminal 30 may be 0.15 mm.

The present invention has been explained using preferred embodiments. The description above does not limit the present invention and various modifications of the embodiments are, of course, possible. For example, in the above-described embodiments, the alkaline dry batteries have been explained. However, depending on selection of materials for power-generating elements included in the battery case 1, the present invention can be, of course, applied to AA cell manganese dry batteries, lithium batteries, nickel hydride storage batteries, and the like.

Moreover, in the above embodiments, the battery case was configured so as to also serve as one of the electrode terminals. However, a configuration in which a base portion of a battery case is shaped to be substantially flat, and then an electrode terminal is united with the base portion by welding, or the like may be adopted.

### INDUSTRIAL APPLICABILITY

The present invention is preferably used as a large-capacity AA battery for a power supply of any devices.

### DESCRIPTION OF REFERENCE CHARACTERS

1 Battery Case
2 Positive Electrode
3 Negative Electrode
4 Separator
5 Gasket
6 Negative Electrode Current Collector
7 Negative Electrode Terminal Plate
8 Exterior Label
9 Sealing Body
10 Battery
20 Shoulder Portion
30 Positive Electrode Terminal
31 Intermediate Stepped Portion
40 Battery Holder
50 Spring
60 Crimped Portion

1. An AA battery comprising:
power-generating elements included in a cylindrical battery case with a base; and
a positive electrode terminal formed at the center of a bottom surface of the battery case, wherein
a maximum outer diameter L (mm) of the battery and a radius r (mm) of an arc of a shoulder portion close to the positive electrode terminal of the battery case satisfy the following relationships:
14.20 mm≦L≦14.35 mm, and
r≧L−13.9 mm.

2. The AA battery of claim 1, wherein
the radius (r) of the arc of the shoulder portion close to the positive electrode terminal of the battery case is 1.2 mm or smaller.

3. The AA battery of claim 1, wherein
the radius (r) of the arc of the shoulder portion close to the positive electrode terminal of the battery case is 0.5 mm or larger,
the positive electrode terminal is made of a raised portion formed at the center of the bottom surface of the battery case, and
a height of the raised portion is in a range from 1.48 mm to 1.60 mm.

4. The AA battery of claim 1, wherein
an outer diameter of the battery case is in a range from 13.95 mm to 14.15 mm.

5. The AA battery of claim 4, wherein
an outer diameter of the battery case is 14.00 mm or larger.

6. The AA battery of claim 4, wherein
an outer diameter of the battery case is 14.05 mm or larger.

7. The AA battery of claim 1, wherein
the battery is an alkaline battery.
